(19) United States
(12) Patent Application Publication
(10) Pub. No.: US 2003/0227641 A1
(43) Pub. Date: Dec. 11, 2003

(54) Mobile USB printer driver

(75) Inventors: Jonathan A. Edmonds, Silverton, OR (US); David M. Chapin, Gresham, OR (US); Patrick K. Sheehan, Clackamas, OR (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/165,592

(22) Filed: Jun. 7, 2002

(51) Int. Cl. G06F 3/12; G06F 15/00; G06F 13/00

(52) U.S. Cl. 358/1.13; 358/1.15; 710/15

(57) ABSTRACT

A USB printer driver includes a generic driver for generating a print job in a page description language for each of a plurality of different printer types; a detector for detecting any USB enabled printers connected to a USB port on a host device; means, responsive to detection of a USB enabled printer connected to the USB port on the host device, for retrieving the detected USB enabled printer's device name; means, responsive to the printer's device name, for generating a print path between the host device and the detected USB enabled printer; and a spooler for sending the print job to the detected USB enabled printer using the print path.

### CROSS REFERENCE TO RELATED APPLICATIONS

This application is related to co-pending U.S. application Ser. No. 10/082,980 filed Feb. 25, 2002, “System for Installing a Printer Driver on a Network” and U.S. application Ser. No. 10/083,209 filed Feb. 25, 2002, “System for Installing a Printer Driver on a Network”, the contents of which are incorporated herein by reference.

This application is related to applicants' co-pending, co-assigned U.S. applications entitled Method of Print-Time Printer Selection (Docket No. D/A2201) and Multiple Printer Driver (Docket No. D/A2200), which are filed concurrently with this application. the contents of which are incorporated herein by reference.

### FIELD OF THE INVENTION

The invention generally relates to a printer driver and more particularly to a mobile USB printer driver which automatically detects a USB connection and provides automatic printer configuration.

### BACKGROUND OF THE INVENTION

Mobile professionals have difficulty printing documents while away from known territories. A common problem lies in the lack of compatible printer drivers for the multitude of different printers they may have access to on the road. Even if the drivers are available, the mobile professional must install the drivers for all the possible printers and maintain a large list of print queues on the professional's personal computer (PC). This is cumbersome at best, and unnecessarily clutters up the user's printers folder and complicates printer selection during printing.

Another common problem mobile professionals have is finding a connection to a desired printer. If the printer is on a network, the professional must have network connectivity and know how to connect to a desired printer on the network. The mobile professional may be able to see the printer in the next room, but finding that printer's address on the network is often difficult. If the mobile professional cannot connect to a network or there is no network available, the user must find a printer with a parallel port or a USB port connection and connect directly.

Connecting to a printer using a parallel port on the user's laptop is fairly straightforward. Connecting to a printer using a USB port is far from straightforward and frequently not even an option. Operating systems such as Windows 2000, Windows XP, and Windows Millennium Edition (Windows Me) supply a general kernel-mode USB print driver, Usbprint.sys, which works with the system-supplied port monitor Usbmon.dll to provide end-to-end connectivity between USB printers and high-level printer drivers. However, printer manufacturers must either write high-level printer drivers that rely on Usbprint.sys or write their own kernel-mode USB print drivers. While some USB printer drivers exist, they are very difficult to obtain, especially for a mobile professional on the road.

### SUMMARY OF THE INVENTION

A USB printer driver, according to one aspect of the invention, includes a generic driver for generating a print job in a page description language for each of a plurality of different printer types; a detector for detecting any USB enabled printers connected to a USB port on a host device; means, responsive to detection of a USB enabled printer connected to the USB port on the host device, for retrieving the detected USB enabled printer's device name; means, responsive to the printer's device name, for generating a print path between the host device and the detected USB enabled printer; and a spooler for sending the print job to the detected USB enabled printer using the print path.

The USB printer driver combines a generic driver interface and automated USB printing device detection. The USB printer driver allows a user to automatically print to a USB connected printer at print time. A user can install the USB printer driver on a laptop. When a user travels, the user need only connect to a printer with a USB connection. Once connected, the user need only select a document to print. When the print window opens, the user selects the USB printer. This driver then automatically scans the USB port for USB enabled printers. When a USB enabled printer is found, the USB printer driver sends the print job to that printer without user intervention or subsequent driver installation.

A system for print-time printer selection, according to another aspect of the invention, includes a printer driver installed on a host device such as a personal computer or laptop computer. The printer driver has the capability to control a plurality of different printer types and also to listen for a printer's identification. The system also includes a beacon, located at the printer which, responsive to a user's activation of the beacon at the printer, broadcasts the printer's identification on the network. When the printer driver receives the user-selected printer identification identifying the printer as one of the plurality of printer types supported by the printer driver, the printer driver sends the user's print job to the identified printer. The beacon is located at the printer and may be implemented as software stored in the printer's firmware, such as the network code region of the firmware. The beacon broadcasts information on the network using whatever protocol is used by the network it is connected to, such as TCP/IP.

The system of the invention provides print-time printer selection by enabling a user to physically select the printer of choice when the user selects the print function. The user installs a printer driver that is capable of controlling several different printer types and to respond to a printer identification signal. Once installed on the user's host device, when the printer driver is selected as the default printer, the driver prompts the user to physically select the desired printer. The user walks over to the desired printer, and activates the printer's beacon. The printer's beacon broadcasts an identification signal on the network. The printer driver listens for the printer's identification signal. When it is received, the printer driver sends the user's print job to the identified printer. The document spools and prints to the printer the user picked. Optionally, information about that printer may be cached on the user's computer for future use.

A system for print-time printer selection removes the ambiguity of multiple printers on a network by allowing the user to make a physical connection to the desired printer. When a user decides to print a document from the user's host device (e.g., PC or laptop), the user is instructed to go to the printer the user wants to print from and activate the printer's beacon from the printer's front panel. The beacon, responsive to an input (such as a user pressing a button at the printer's control panel), broadcasts the printer's identification information. This identification information may include the printer's model name and distinguishing network information. When the printer driver receives the information, the user's print job is directed to that printer.

### BRIEF DESCRIPTION OF THE DRAWINGS

FIG. 1 is a block diagram of a system employing a method of print-time printer selection;

FIG. 2 is a block diagram illustrating operation of a smart USB printer driver; and

FIG. 3 is a drop down menu illustrating various printers installed on a particular application.

### DETAILED DESCRIPTION OF THE EMBODIMENT

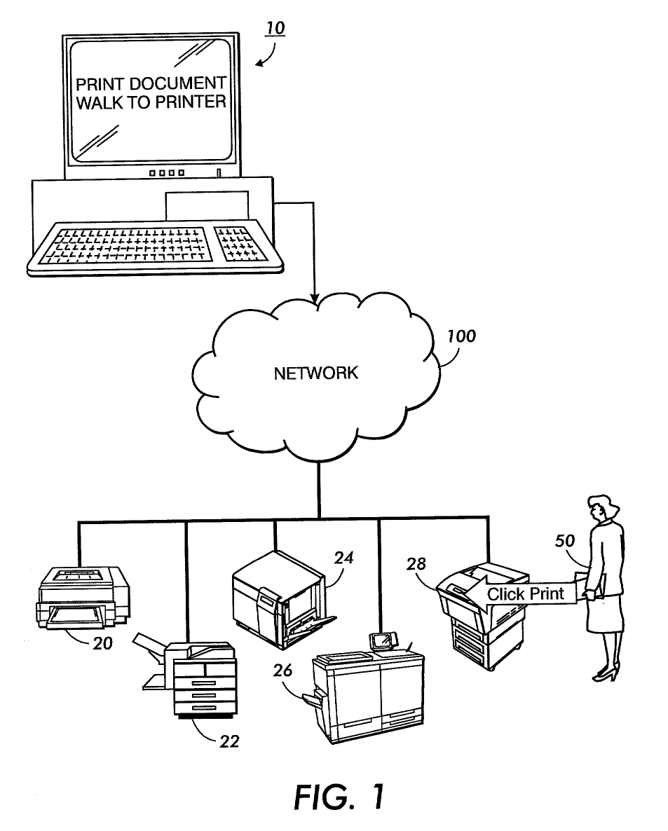

Referring to FIG. 1, a system for print-time printer selection includes a printer driver installed on a host device 10, which is shown as a personal computer connected to network 100. Printers 20, 22, 24, 26 and 28 are also connected to network 100. The printer driver is capable of controlling, in this example, all of the printers shown in FIG. 1. In order to control each printer 20, 22, 24, 26 and 28, the printer driver must be capable of translating a print job from an application program into the appropriate page description language (PDL) for any supported printer. Each printer 20, 22, 24, 26 and 28 includes a menu or button or other user-accessible means to select that printer to print at that particular time.

The printer driver may be a standalone printer driver, which is installed like any other printer driver, with the distinction that this printer driver has additional functionality. Alternatively, the printer driver may be in the form of a plug-in to an existing application program. The printer driver must be capable of generating printer-independent PDL (such as PostScript) that will successfully print to any supported printer. The list of supported printers is not necessarily small, and could encompass a large variety of devices. The printer driver may support any number of printer features and page sizes, depending on the implementation and marketing goals of the end product. The printer driver may also include a port monitor, and a language monitor that, as part of the system, are capable of interrupting a print job in-progress, allowing the user to specify to which printer to print their document. The printer driver may optionally be capable of submitting a user password with the print job such that security is maintained when desired across the system of printers and PCs.

Each printer in this system must include some means by which a user may select the printer for “mobile” or “beacon” or print-time printing. The system of the invention is beneficial for mobile users as well as fixed users. This selection mechanism, or beacon, may include a menu item, a button, a switch or such other means available to the user on the printer. The printer in this system, responsive to user activation of the beacon, communicates with the user's PC through a network broadcast message such that the PC may become aware of the user's selection. The user's PC and printer may communicate directly if they are connected via a parallel port or serial port. The printer in this system may optionally require successful submission of the document's password (as provided through the printer driver) prior to printing the document.

The system of print-time printer selection may be used when a user opens a document on the user's PC. The user selects the print function from the application program used to open the document. Under printer properties, the user selects the “beacon” printer. The beacon printer dialog box opens and prompts the user to make a physical selection of a printer. The user walks to the desired printer (in this case printer 28) and selects the printer through some interface resident on that printer (such as pushing a print button).

Printer 28 includes beacon technology which broadcasts certain identification information on the network in response to appropriate selections on the printer's panel menu. When the user follows the instructions provided, this feature is activated, and the printer 28 will attempt to communicate with the user's PC 10. In this case, the user 50 wants to print her document to printer 28. User 50 highlights the “Printer Identification” selection on the printer 28's menu and presses “OK” and highlight the “Select for Print” and presses “OK”. These steps activate the beacon on printer 28.

When the beacon is activated, the beacon (which may be implemented in printer 28's firmware) then broadcasts a communication packet containing whatever predetermined information has been stored for broadcasting. This communication packet contains a special packet of data that the PC 10 is listening for. This packet contains enough distinguishing information such that the host machine knows which printer sent it. The listening PC 10 receives this packet and then the printer driver uses this information to determine if printer 28 is supported. The data packet broadcast by the beacon may contain the IP address of the printer. Once the packet is received, the user's PC 10 may contact the printer 28 directly over the network using the network protocol, such as TCP/IP and sending the user's print job. A specific printer was chosen at this point by the user, removing any ambiguity there may have been in the list of possible printers to work with.

Printer 28 communicates via a broadcast message to all PCs on the printer's network. If the user's PC 10 is on the same network, the user's PC 10 replies to the printer's broadcast message with the print job information. Printer 28 may optionally broadcast a message prompting the user to enter password (if the print job is password enabled). User 50 enters password which is communicated to printer 28. If the password is correct, printer 28 notifies the user's PC 10 to submit the print job. The printer driver sends the print job to the printer 28. When the print job is completed, the printer 28 sends a message that the print job is complete to the user's PC 10. The user retrieves the completed print job at printer 28.

The following exemplary code checks to see if the selected printer is a beacon printer, i.e., one in which the user must activate the printer by physically walking to the selected printer, pushing a button on the printer. When the user pushes the button on the printer, the printer broadcasts its URL to the multiple printer driver.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

A system for mobile USB printing, includes a USB printer driver installed on a USB enabled host device, for automatically detecting and printing to a USB enabled printer, wherein the USB printer driver includes a generic driver for generating a print job in a page description language for each of a plurality of different printer types; a detector for detecting any USB enabled printers connected to a USB port on a host device; means, responsive to detection of a USB enabled printer connected to the USB port on the host device, for retrieving the detected USB enabled printer's device name; means, responsive to the printer's device name, for generating a print path between the host device and the detected USB enabled printer; and a spooler for sending the print job to the detected USB enabled printer using the print path; and a USB enabled printer connected to the host device via a USB connection.

The USB printer driver includes a generic print driver which is capable of creating or generating a print job in an appropriate PDL (such as printer-independent PostScript) for any supported printer. Any USB enabled printer may be used in the system, for example, USB Plug'n Play capable printer. The generic driver may be in the form of a print driver, or a print driver plug-in for use in an application having a print functionality. The list of supported printers is not necessarily small, and could encompass a large variety of devices. The generic driver could support any number of printer features and page sizes, depending on the implementation and marketing goals of the end product. The USB printer driver may also include a port monitor or a language monitor for automatically detecting a USB connected printer and diverting the print job to that printer.

One embodiment of the automatic USB detection uses the Plug 'n Play technology inherent to Windows 2000/XP operating systems (as well as other Microsoft operating systems). Once invoked, the USB printer driver will scan the USB devices for a connected printer, and capture the USB device's product name. If the product name is in the supported list of printers, the print job is spooled through a port monitor to disk, and then sent to the printer directly from the spooler.

The USB printer driver may be implemented for many different operating systems. The following example is based on an implementation for a Windows operating system using Windows calls. The USB printer driver scans or detects for currently connected USB devices. For each found USB device, the USB printer driver creates a fully qualified device path (e.g., one which is suitable for a CreateFile call in Windows). The general approach is as follows:

Obtain a list of all present USB printer devices using SetupDiGetClassDevs( ) API Call.

Enumerate through all the devices in the list using SetupDiEnumDeviceInfo( ).

Try to open the device's registry key using SetupDiOpenDevRegKey( ).

If that succeeds, try to open the device's symbolic name using RegQueryValueEx( ).

If that succeeds, return the symbolic name as the fully qualified path for use with CreateFile( ).

The USB printer driver opens the Windows registry key for all the detected USB enabled printers. The USB printer's symbolic name is retried and then formatted so that it may be used in a CreateFile call. The formatted symbolic name is used as a parameter in the CreateFile call. Then the USB printer driver opens a file handle to the printer and the print job is sent.

This bypasses the standard usbmon.dll port monitor provided by Windows. Instead, the print job is re-routed through the USB printer driver's spooler, which opens the USB port, and spools the document directly to the discovered printer. This technique is further described in the following exemplary code of a portion of a mobile USB printer driver according to one embodiment of the invention which determines whether or not a USB printer is connected and if so, obtains the printers fully qualified path and user-friendly name.

/************************************************************

| | |
|---|---|
| ** | IsUSBPrinterConnected |

| | | |
|---|---|---|
| ** | Purpose: | To provide ability to determine if a printer is connected USB |
| ** | | currently. Returns the name of the USB printer and the fully |
| ** | | qualified path to print to. sizePrinterName and sizePath must be |
| ** | | set to the acutal size in bytes of the buffers being passed |
| ** | | (not the string length in TCHARs). |

************************************************************/
bool IsUSBPrinterConnected (TCHAR *szPrinterName, DWORD sizePrinterName,
TCHAR *szPath, DWORD sizePath)
{

HDEVINFO hDevInfo;
SP_DEVINFO_DATA DeviceInfoData;
DWORD i;

bool bRetVal = false;

// Create a HDEVINFO with all present devices.
hDevInfo = SetupDiGetClassDevs(NULL,

_T(“USB”),//Enumerator
0,
DIGCF_PRESENT | DIGCF_ALLCLASSES);

if (hDevInfo == INVALID_HANDLE_VALUE)
{

// Insert error handling here.
return false;

}
// Enumerate through all devices in Set.
DeviceInfoData.cbSize = sizeof(SP_DEVINFO_DATA);
for (i=0;SetupDiEnumDeviceInfo(hDevInfo,i,

&DeviceInfoData);i++)

{

DWORD DataT;

| // | LPTSTR buffer = NULL; |
|---|---|
| | DWORD buffersize = 0; |
| | // |
| | // Call function with null to begin with, then use the returned buffer size to Alloc |
| | // the buffer. Keep calling until success or an unknown failure. |
| | // |
| | if (SetupDiGetDeviceRegistryProperty( |

hDevInfo,
&DeviceInfoData,
SPDRP_LOCATION_INFORMATION ,

| // | SPDRP_DEVICEDESC, |
|---|---|
| | &DataT, |
| | (PBYTE)szPrinterName, |
| | sizePrinterName, |
| | NULL)) { |

//this means that it's hooked up.
//MessageBox(NULL, buffer,_T(“Found USB Printer”), MB_OK);
//ERROR CHECK HERB!!!!! MAKE SURE IT'S THE RIGHT PRINTER

| | HKEY hKey = |
|---|---|
| | SetupDiOpenDevRegKey(hDevInfo,&DeviceInfoData,DICS_FLAG_GLOBAL, |
| | 0,DIREG_DEV, KEY_READ); |
| | DWORD oops = GetLastError( ); |
| | if (hKey != INVALID_HANDLE_VALUE) { |
| // | TCHAR junk[500]; |
| | DWORD size = sizePath; |
| | oops = RegQueryValueEx(hKey, _T(“SymbolicName”), NULL, NULL, |

(PBYTE)szPath, &sizePath);

if (oops == ERROR_SUCCESS) {

//now, format the information
//what used to look like “/??/USB...” needs to look like “//./USB....”

| | | |
|---|---|---|
| szPath[0] = 92; | // | '/' |
| szPath[1] = 92; | // | '/' |
| szPath[2] = '.'; | // | '.' |
| szPath[3] = 92; | // | '/' |
| bRetVal = true; | | |

}

}

}

}

// Cleanup
SetupDiDestroyDeviceInfoList(hDevInfo);

return bRetVal;

}

The following exemplary code of a portion of a mobile USB printer driver according to one embodiment of the invention describes the functionality that allows the driver to automatically direct the job to the appropriate USB printer using a spooler.

***********************************************************************
** LcmStartDocPort
**
**

| | | |
|---|---|---|
| ** | Purpose: | This is where much of the interesting things take place. We need to |
| ** | | determine if we are the walk-up printer driver, and if so, launch the |
| ** | | applicable dialog. Also, we need to create the appropriate spool file |
| ** | | and job ticket. |

```
***********************************************************************
BOOL
LcmStartDocPort(
  HANDLE hPort,
  LPWSTR pPrinterName,
  DWORD JobId,
  DWORD Level,
  LPBYTE pDocInfo)
{
  PINIPORT pIniPort = (PINIPORT)hPort;
  HANDLE hToken;
  PDOC_INFO_1 pDocInfo1 = (PDOC_INFO_1)pDocInfo;
  DWORD Error = 0;
```

OutputDebugString(_T(“LcmStartDocPort\n”));

DBGMSG(DBG_TRACE, (“StartDocPort(%08x, %ws, %d, %d, %08x)\n”,

hPort, pPrinterName, JobId, Level, pDocInfo));

```
  if (pIniPort->Status & PP_STARTDOC) {
    return TRUE;
  }
  LcmEnterSplSem( );
  pIniPort->Status |= PP_STARTDOC;
  LcmLeaveSplSem( );
  pIniPort->hPrinter = NULL;
  pIniPort->pPrinterName = AllocSplStr(pPrinterName);
  if (pIniPort->pPrinterName) {
    if (OpenPrinter(pPrinterName, &pIniPort->hPrinter, NULL)) {
```

//try to get the job name (cast it to a doc_info_1

structure, even though it might be doc_info_2

_tcscpy(szJobDispName, ((DOC_INFO_1

*)pDocInfo)->pDocName);

pIniPort->JobId = JobId;

//create some file paths
//get the base path
TCHAR szBasePath[64];
TCHAR szJobPath[MAX_PATH];
//Get the Base path from the registry
if(!_SpoolerJobTicketClass::GetSpoolPath(szBasePath,

MAX_PATH))

_tcscpy(szBasePath,_T(“c:\\temp\\”));

//the job will be called

<base_path>\opb_spool_<job_id>.prn

_stprintf(szJobPath,

_T(“%sopb_spool_%d.prn”),szBasePath,JobId);

//right here, we need to know if we are the Walk-up

Printer Driver. Only this driver

//will prompt the user at print time for an IP

address.

if (IsWalkupPrinter(pIniPort->hPrinter)) {

//we know we need to launch our dialog
TCHAR szIPAddress[MAX_PATH];
TCHAR szPrinterModel[MAX_PATH];
_SpoolerJobTicketClass::PORT_TYPE PortType =

_SpoolerJobTicketClass::_IP;

//memset (szIPAddress, 0,

sizeof(szIPAddress));

HWND hParent = GetForegroundWindow( );
//see if they have printed recently
int rc = IDNO; //this is a way to always

drop into the next line if we don't call this

//update our timer value based on user's

settings

global_timer_value =

GetCountdownTimerValue( );

//check for USB
if (IsUSBPrinterConnected (szPrinterModel,

MAX_PATH, szIPAddress, MAX_PATH)) {

rc = DialogBoxParam(LcmhInst,

MAKEINTRESOURCE(DLG_NOTIFICATION), hParent,

(int

(__stdcall *)(void))&PrintNoticeProc, (LPARAM)szPrinterModel);

if (rc == IDOK)

PortType =

_SpoolerJobTicketClass::_USB;

}
else if (PrintToLast(pIniPort->hPrinter)) {

GetLastCachedIP(pIniPort->hPrinter,

szIPAddress);

rc = DialogBoxParam(LcmhInst,

MAKEINTRESOURCE(DLG_NOTIFICATION), hParent, (int (_stdcall
*)(void))&PrintNoticeProc, (LPARAM)szIPAddress);

}
//this will be called either if PrintToLast

is false, or if the user wishes to choose another printer

if (rc == IDNO) {

//we let them choose
//be kind of tricky, and pass the

Printer name through this IP address variable

_tcscpy(szIPAddress,pPrinterName);
rc = DialogBoxParam(LcmhInst,

MAKEINTRESOURCE(DLG_WALKUP), hParent, (int (_stdcall
*)(void))&WalkupProc, (LPARAM)szIPAddress);

}
//this will be the value if the user either

lets the print to last dialog run it's course, or chooses a specific printer
themselves

if (rc == IDOK) {

//we go ahead and print...
//the user has successfully selected

something

//MessageBox(hParent, szIPAddress,

NULL, MB_OK);

TCHAR szJobTicketPath[MAX_PATH];
//the ticket will be called

<base_path>\opb_spool_<job_id>.tkt

_stprintf(szJobTicketPath,

_T(“%sopb_spool_%d.tkt”),szBasePath,JobId);

_SpoolerJobTicketClass NewJobTicket;
//copy the job name

_tcscpy(NewJobTicket.pJobTicket->szJobName, ((DOC_INFO_1
*)pDocInfo)->pDocName);

//we only support 1 printer for

walk-up
NewJobTicket.pJobTicket->dwTotalAvailablePrinters = 1;

//initialize the printer (only one

of them for walk-up)
NewJobTicket.pJobTicket->printerInfo[0].enumPortType=PortType;
_tcscpy(NewJobTicket.pJobTicket->printerInfo[0].szPortVal, szIPAddress);

//now, write it out
LaunchOPBSpooler( );

NewJobTicket.WriteJobTicketToDisk(szJobTicketPath);

_SpoolerJobTicketClass test;

test.ReadJobTicketFromDisk(szJobTicketPath);

}
//this will be the case if the user cancels

either the print to last dialog, or the choose printer dialog

else if (rc == IDCANCEL) {

//we cancel the job
DWORD retVal =

SetJob(pIniPort->hPrinter, JobId, 0, NULL, JOB_CONTROL_SENT_TO_PRINTER);

retVal = SetJob(pIniPort->hPrinter,

JobId, 0, NULL, JOB_CONTROL_DELETE);

}

}

//
// For non dosdevices CreateFile on the name of the port
//
pIniPort->hFile = CreateFile(szJobPath,//pIniPort->pName,

GENERIC_WRITE,
FILE_SHARE_READ,
NULL,
OPEN_ALWAYS,
FILE_ATTRIBUTE_NORMAL |
FILE_FLAG_SEQUENTIAL_SCAN,
NULL);

if (pIniPort->hFile != INVALID_HANDLE_VALUE)

SetEndOfFile(pIniPort->hFile);

```
    }
  } // end of if (pIniPort->pPrinterName)
  if (pIniPort->hFile == INVALID_HANDLE_VALUE)
    goto Fail;
```

bNewStart = TRUE;

```
  return TRUE;
Fail:
  SPLASSERT(pIniPort->hFile == INVALID_HANDLE_VALUE);
  LcmEnterSplSem( );
  pIniPort->Status &= ˜PP_STARTDOC;
  LcmLeaveSplSem( );
  if (pIniPort->hPrinter) {
    ClosePrinter(pIniPort->hPrinter);
  }
  if (pIniPort->pPrinterName) {
    FreeSplStr(pIniPort->pPrinterName);
  }
  if (Error)
    SetLastError(Error);
  return FALSE;
}
```

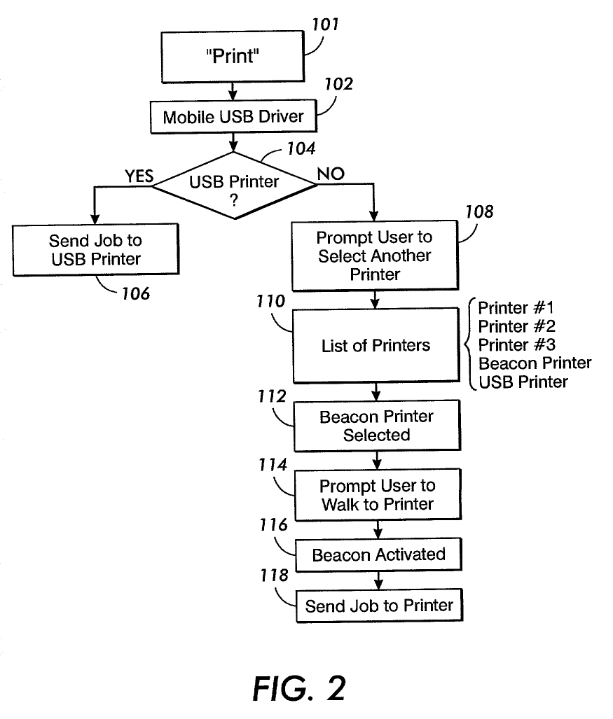

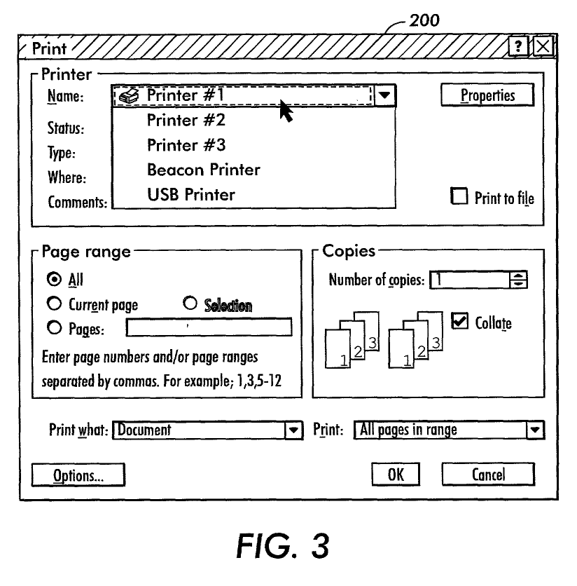

The USB printer driver automatically detects a USB enabled printer connected to the user's PC. Referring to FIG. 2, the user selects print (step 101) from an application running on the user's PC. If the USB printer is selected as the default printer (or manually selected by the user) (step 102), the USB printer driver checks to see if a USB printer is connected to the USB port (step 104). If yes, the USB printer driver sends the job to the USB printer (step 106). If there is no USB printer connected, or if the USB printer connected is not supported by the USB printer driver, the user is prompted to select another printer (step 108). A dialog box displaying a list of available printers (step 110) such as those on FIG. 3 is displayed to the user. Alternatively, the dialog box may display a list of recently used printers. The dialog box may display the list of available printers by IP address, by DNS name, by UNC path. Suppose the user selects the beacon printer (step 112). The beacon printer driver then prompts the user to walk to the desired printer (step 114). At the desired printer, the user activates the beacon (step 116). The beacon driver then sends the print job to that printer.

The beacon printer driver and the USB printer driver can be installed on the same PC. Referring to FIG. 3, in the printer dialog box 200, a user may select from any of printer #1, printer #1, printer #3, beacon printer and USB printer. If the user selects the beacon printer for printing, then the user will be prompted to physically activate the beacon at the desired printer. If the user is travelling, the user may select the USB printer and connect to a USB enabled printer.

The invention has been described with reference to a particular embodiment. Modifications and alterations will occur to others upon reading and understanding this specification taken together with the drawings. The embodiments are but examples, and various alternatives, modifications, variations or improvements may be made by those skilled in the art from this teaching which are intended to be encompassed by the following claims.

What is claimed is:

1. A USB printer driver, comprising:
a generic driver for generating a print job in a page description language for each of a plurality of different printer types;
a detector for detecting any USB enabled printers connected to a USB port on a host device;
means, responsive to detection of a USB enabled printer connected to the USB port on the host device, for retrieving the detected USB enabled printer's device name;
means, responsive to the printer's device name, for generating a print path between the host device and the detected USB enabled printer; and
a spooler for sending the print job to the detected USB enabled printer using the print path.

2. The driver of claim 1, wherein the means for retrieving the detected USB enabled printer's device name retrieves the detected USB enabled printer's symbolic name;
further comprising means for formatting the symbolic name into a valid format for use in a CreateFile call; and
wherein the means for generating a print path between the host device and the detected USB enabled printer comprises generating a CreateFile call using the formatted symbolic name.

3. The driver of claim 1, wherein the spooler opens the USB port and spools the print job directly to the detected USB enabled printer.

4. The driver of claim 1, wherein the detector comprises a SetupDiGetClassDevs( ) API call to obtain a list of all present printer devices.

5. The driver of claim 4, further comprising a SetupDiEnumDeviceInfo( ) call to enumerate through all the devices in the list of present printer devices.

6. The driver of claim 5, wherein the means for retrieving the detected USB enabled printer's device name comprises SetupDiOpenDevRegKey( ) for opening the printer's registry key.

7. The driver of claim 6, further comprising RegQueryValueEx( ), responsive to an opened registry key, for obtaining the printer's symbolic name.

8. The driver of claim 7, wherein the means for generating a print path comprises CreateFile using the printer's symbolic name.

9. The driver of claim 1, further comprising a user interface, responsive to the detector, for displaying USB enabled printer detection information.

10. The driver of claim 9, wherein the user interface, responsive to the detector, for prompting the user to select another printer when the detector fails to detect any connected USB enabled printer.

11. A system for mobile USB printing, comprising:
USB printer driver installed on a USB enabled host device, for automatically detecting and printing to a USB enabled printer, wherein the USB printer driver includes a generic driver for generating a print job in a page description language for each of a plurality of different printer types; a detector for detecting any USB enabled printers connected to a USB port on a host device; means, responsive to detection of a USB enabled printer connected to the USB port on the host device, for retrieving the detected USB enabled printer's device name; means, responsive to the printer's device name, for generating a print path between the host device and the detected USB enabled printer; and a spooler for sending the print job to the detected USB enabled printer using the print path; and
a USB enabled printer connected to the host device via a USB connection.

12. The system of claim 11, wherein the USB enabled host device comprises a portable PC having a USB port.
